(19) United States
(12) Patent Application Publication
(10) Pub. No.: US 2025/0374915 A1
(43) Pub. Date: Dec. 11, 2025

(54) PORTABLE MARINE MAMMAL DETERRENCE APPARATUS AND SYSTEM

(71) Applicant: The United States of America as represented by the Secretary of the Navy, San Diego, CA (US)

(72) Inventors: Ralph David Hooper, Lemon Grove, CA (US); William Chambers, Jamul, CA (US); Christopher Zirkle, Oceanside, CA (US); Taylor Doolittle, San Diego, CA (US); Karl Anders Lindman, Chula Vista, CA (US); Joshua James Erick, San Diego, CA (US); Nigel Holman, San Marcos, CA (US); Kelly Krueger, La Mesa, CA (US)

(73) Assignee: The United States of America as represented by the Secretary of the Navy, San Diego, CA (US)

(21) Appl. No.: 18/734,318

(22) Filed: Jun. 5, 2024

(51) Int. Cl. A01M 29/24; B63B 59/00

(52) U.S. Cl. CPC A01M 29/24; B63B 59/00

(57) ABSTRACT

A portable marine mammal deterrence apparatus or system comprising an insulated cable capable of coupling to an aquatic vessel; a plurality of cable offshoots, each having a proximal end and a distal end, wherein each proximal end is electrically connected to the insulated cable; a plurality of deterrence tips, each located at the distal end of each of the plurality of cable offshoots, wherein a marine mammal contacting at least two deterrence tips forms a circuit that provides a deterrent stimulus; a control system, electrically connected to the insulated cable, designed to selectively electrify the circuit when a resistance is within a deterrence range, further comprising: a resistance detector configured to measure a resistance of the circuit, a relay configured to enable electrification of the circuit, and an alert module configured to provide an intruder notification; and a power source capable of electrifying the circuit.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC_Pacific_T2@us.navy.mil, referencing Navy Case No. 211,394.

### FIELD OF USE

The present disclosure pertains generally to deterrence apparatuses and systems for marine mammal, including pinnipeds.

### BACKGROUND

Pinnipeds, such as seals, sea lions, and walruses, will leave their ocean environment to rest, defecate, and mate. In leaving the water, they may board piers, buoys, boats, decks, and other types of maritime platforms on which they can rest. Unfortunately, when they do so they can significantly damage the vessel in the process.

Various deterrence systems for pinnipeds exist including physical barricades, stainless steel electrical strips, chemical irritants, cattle prods, hoses, and acoustic devices having varying success rates. Many of these aforementioned techniques are often only useful in specific use cases. Furthermore, it is desirable to deter pinnipeds in accordance with techniques that are compliant with National Oceanic and Atmospheric Administration regulations. Specifically, Section 101(a)(4) of the Marine Mammal Protection Act allows for the non-lethal deterrence of nuisance animals under certain circumstances. Accordingly, there is a need for a pinniped deterrence apparatus, system, and method that is flexible in its possible applications to provide non-lethal deterrence.

### SUMMARY

According to illustrative embodiments, a portable marine mammal deterrence apparatus, comprising: an insulated cable capable of coupling to an aquatic vessel; a plurality of cable offshoots, each having a proximal end and a distal end, wherein each proximal end is electrically connected to the insulated cable; a plurality of deterrence tips, each located at the distal end of each of the plurality of cable offshoots, wherein a marine mammal contacting at least two deterrence tips forms a circuit that provides a deterrent stimulus; a control system, electrically connected to the insulated cable, designed to selectively electrify the circuit when a resistance is within a deterrence range, further comprising: a resistance detector configured to measure a resistance of the circuit, a relay configured to enable electrification of the circuit, and an alert module configured to provide an intruder notification; and a power source, electrically connected to the control system, capable of electrifying the circuit.

Additionally, a portable marine mammal deterrence system, comprising: an insulated cable capable of coupling to an aquatic vessel; a plurality of cable offshoots, each having a proximal end and a distal end, wherein each proximal end is electrically connected to the insulated cable; a plurality of deterrence tips, each located at the distal end of each of the plurality of cable offshoots, wherein a marine mammal contacting at least two deterrence tips forms a circuit that provides a deterrent stimulus; a control system, electrically connected to the insulated cable, designed to selectively electrify the circuit when a resistance is within a deterrence range, further comprising: a resistance detector configured to measure a resistance of the circuit, a relay configured to enable electrification of the circuit, and an alert module configured to provide an intruder notification; and a power source, electrically connected to the control system, capable of electrifying the circuit.

It is an object to provide a Portable Marine Mammal Deterrence Apparatus and System that offers numerous benefits, including repelling pinnipeds and other marine animals from boarding a vessel to protect the vessels.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1A shows an exemplary computer-generated rendering of an aquatic vessel and a portable marine mammal deterrence apparatus.

FIG. 1B shows an exemplary computer-generated rendering of the insulated cable electrically connected to the plurality of cable off-shoots.

FIG. 2A shows exemplary computer-generated rendering of the portable marine mammal deterrence apparatus coupled to a railing of the aquatic vessel.

FIG. 2B shows an exemplary computer-generated rendering of the portable marine mammal deterrent apparatus coupled to swim steps of an aquatic vessel.

FIG. 3 shows a block diagram illustration of a portable marine mammal deterrent system.

### DETAILED DESCRIPTION OF EMBODIMENTS

The disclosed apparatus and system below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatus and system described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

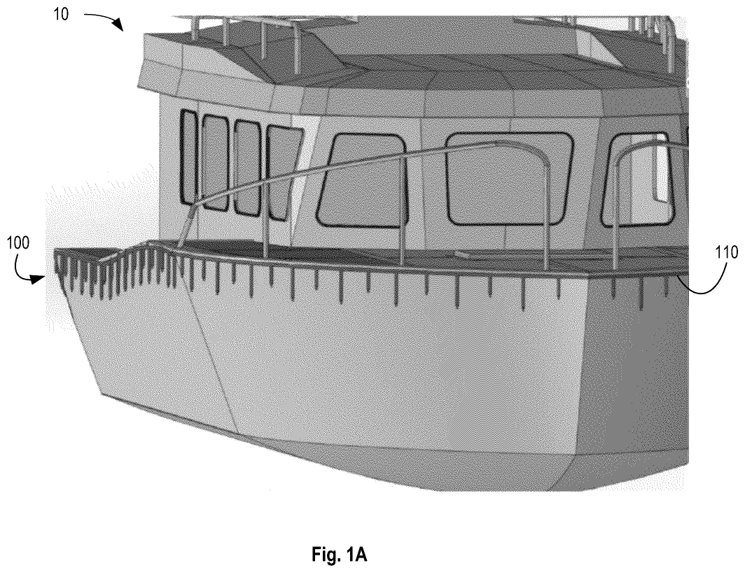

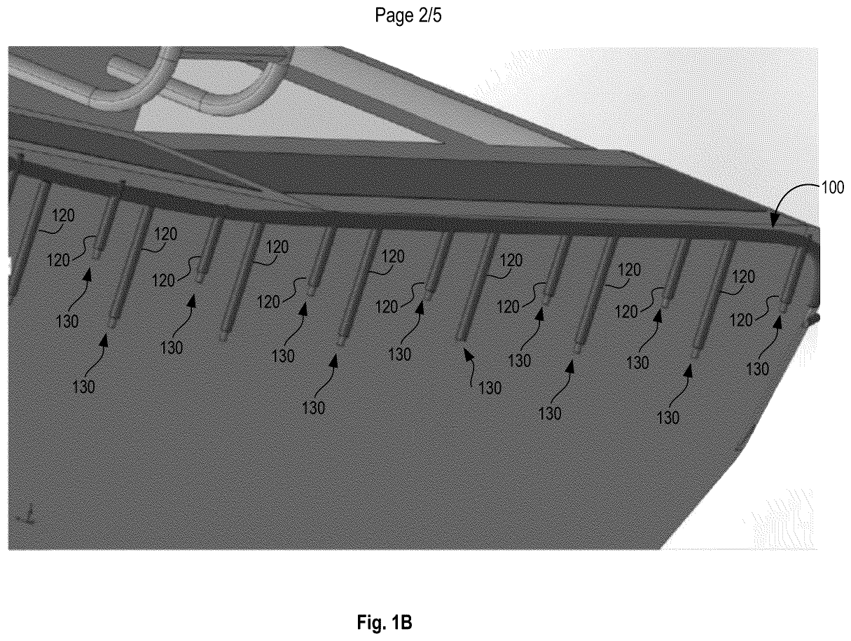

FIG. 1A shows a computer-generated rendering of an aquatic vessel 10 and a portable marine mammal deterrence apparatus 100 comprising an insulated cable 110, electrical offshoots 120, a plurality of deterrence tips 130, a power source 140, and a control system 150. As shown in FIG. 1, the apparatus 100 may couple to the external edge of an aquatic vessel 10 to deter marine mammals from boarding. Marine mammals, such as pinnipeds, may cause extreme damage to aquatic vessels 10 when they board them to rest, defecate, and mate. Primarily, the portable marine mammal deterrence apparatus 100 may be used for stationary vessel 10 and may be turned off if the vessel 10 starts moving to prevent accidental energizing.

The aquatic vessel 10 may comprise, but is not limited to, any boat, ship, deck, buoy, or any other type of marine or marine-adjacent platform. While some applications are centered around oceanic use cases, the subject matter described herein may also be deployed in or near lakes, rivers, and pools. Furthermore, the apparatus 100 is portable in that it may be readily deployed around a certain vessel 10, later removed, and taken to another vessel. Compared to known techniques, this disclosure may be relatively lightweight and compact to aid in portability.

The insulated cable 110 comprises a selectively electrified wire and is capable of coupling to an external edge of an aquatic vessel 10. The insulated cable 110 provides isolation to the electrified wire from the elements, including seawater. Coupling to the aquatic vessel 10 may be performed via hooks, ties, anchors, or other known methods. Notably, the coupling may span the area intended for deterring the marine mammals and positions the portable marine mammal deterrence apparatus 100 above the waterline. The cable 110 has a length relative to the area a user wishes to protect from pinniped intrusion. For example, the system 100 may fully surround the vessel 10 on all sides, such as shown in FIG. 1. Alternatively, the cable 110 may be coupled to one side of a platform 10 or vessel 10, as needed. In one embodiment, the portable marine mammal deterrence apparatus 100 may not be coupled to an aquatic vessel and may be used as standalone intruder deterrent. In another embodiment, the insulated cable 110 may be coupled to swim steps.

Depending on the material of the aquatic vessel 10 (e.g. the hull's material), the cable 110 may be coupled above the edge of a hull, or otherwise situated along an external edge of the aquatic vessel 10. Conductive hulls may cause the apparatus 100 to short, and accordingly may require an adjacent placement of this system.

FIG. 1B shows an exemplary computer-generated rendering of the insulated cable 110 is electrically connected to the plurality of cable off-shoots 120. Each of the plurality of cable offshoots 120 further comprise a proximal end and a distal end. The proximal ends connect to the insulated cable 120 and are spaced along the insulated cable 120. The spacing distance is relative to the size of the marine mammal intended to deter. A marine mammal may trigger the deterrence stimulus by contacting at least two deterrence tips simultaneously. Accordingly, the spacing is sufficiently close for a marine mammal to contact two tips at once while trying to intrude onto the vessel 10. Furthermore, the plurality of cable offshoots 120 are electrically insulated, and further electrically connected to a plurality of deterrence tips 130.

In one embodiment, the plurality of cable offshoots have staggering lengths, as shown in FIG. 1B. Staggering lengths of the cable offshoots may provide benefits including a reduced likelihood of shorting.

The plurality of deterrence tips 130 may each be located at the distal end of each of the plurality of cable offshoots, wherein a marine mammal contacting at least two deterrence tips forms a circuit that provides a deterrent stimulus. In one embodiment, the plurality of deterrence tips 130 are continuation of exposed wires of the cable offshoots. As shown in FIG. 1, the deterrence tips are positioned above the waterline and may be generally oriented to hang down towards the water so that an inbound marine mammal will contact the tips as they get out of the water. When a marine mammal contacts at least two tips, the circuit formed provides an electrical stimulus. The electrical stimulus deters a marine mammal from boarding or intruding onto the aquatic vessel 10. In one embodiment, when a marine mammal, including a pinniped, touches at least two tips the circuit may be selectively energized based on the resistance measured in the circuit.

Furthermore, this stimulus may be tuned to an appropriate level for particular groups of marine mammals, such as pinnipeds. In some embodiments, the stimulus may reflect an appropriate level for applicable statues, regulations, or practices. For example, the deterrent stimulus may be tuned to comply with requirements of the National Oceanic and Atmospheric Administration, who regulate method of deterrence for certain species, such as pinnipeds, while in the water of the United States under the Marine Mammal Protection Act.

In some embodiments, at least one deterrence tip may be directly connected to the insulate cable, instead of being intermediated by a cable offshoot 120.

The power source 140 is electrically connected to the insulated cable capable of electrifying the circuit. In one embodiment, the power source may comprise a battery or a generator. In another embodiment, the power source 140 may comprise a solar array.

The control system 150 may comprise a resistance detector 160, a relay 170, and an alert module 180, and may be electrically connected to the insulated cable and may designed to selectively electrify the circuit when a resistance is within a deterrence range. Example embodiments of a control system include a computer comprising a non-transitory memory, a processor, and a transceiver. In one embodiment, the control system is a single board computer.

Furthermore, the control system 150 may further comprise computer-readable instructions to provide an intruder notification warning an operator of an intrusion. The notification may be communicated through a wired or wireless connection, including LAN, Wi-Fi-and/or Bluetooth.

The control system 150 may further comprise computer-readable instructions to receive and store a measure of the circuit's resistance, determine if the resistance is within a deterrence range, and selectively enable electrification at the relay 170. The deterrence range is a range of appropriate resistances that indicate a marine mammal has contacted at least two deterrence tips. Outside of the deterrence range, the control system may switch the relay off so as to not provide electrification.

The resistance detector 160 may be configured to measure the resistance of the circuit. A resistance measurement may indicate that the circuit is shorted, or that the circuit is open (indicating no current flow), or within a deterrence range suitable to provide an electrification. The resistance measurement may be controlled by a control system 150 to selectively electrify the circuit to a certain current or to cease electrification of the circuit.

The relay 170 may be configured to enable electrification of the circuit by providing power from the power source. Here, the relay 170 may be an electrically operated switch capable of switching on/off the power provided by the power source 140.

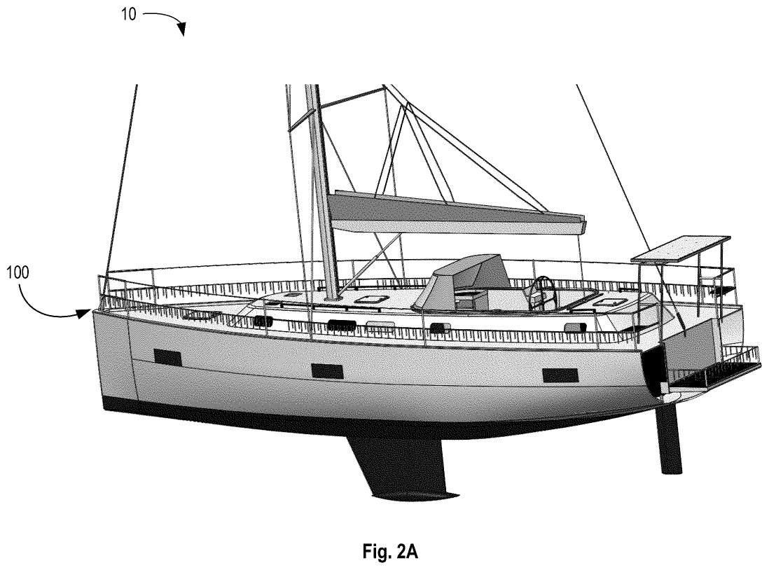

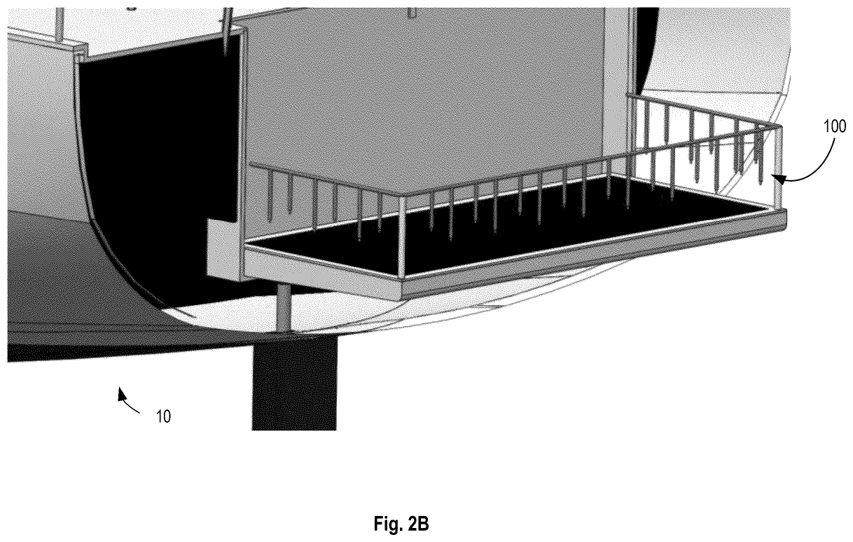

FIG. 2A shows exemplary computer-generated rendering of the apparatus 100 coupled to a railing of the aquatic vessel 10. In one embodiment, the aquatic vessel 10 may be a sailboat and the railing be an external edge of the boat elevated from the hull, as shown.

FIG. 2B shows an exemplary computer-generated rendering of the portable marine mammal deterrent apparatus 100 coupled to swim steps of an aquatic vessel 10. As this is a place that marine mammals enjoy boarding, this is a possible embodiment.

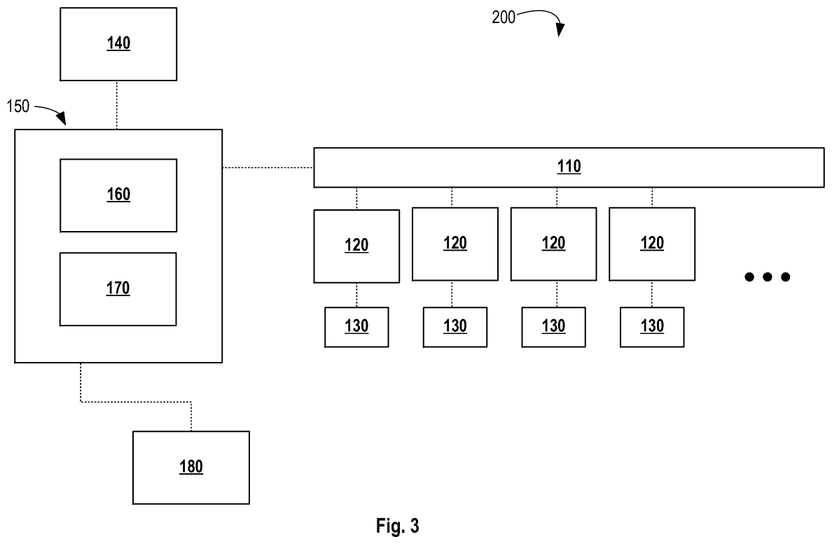

FIG. 3 shows a block diagram illustration of a portable marine mammal deterrent system 200 comprising an insulated cable 110, electrical offshoots 120, a plurality of deterrence tips 130, a power source 140, and a control system 150. This diagram illustrates an exemplary embodiment of the apparatus or system discussed herein with electrical connections symbolized with a dotted line. On the right side of the figure, the three dots are intended to symbolize ellipses-meaning that a plurality of electrical offshoots 120 and deterrence tips 130 may be connected in parallel. In one embodiment, the marine mammal deterrence system 200 may further comprise an alert system 180 comprising, but not limited to, warning signs, signal lights, warning sounds, or an integration with an onboard system of the aquatic vessel 10 that provide information to an operator.

From the above description of Portable Marine Mammal Deterrence Apparatus and System, it is manifest that various techniques may be used for implementing the concepts of Portable Marine Mammal Deterrence Apparatus and Portable Marine Mammal Deterrence System without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that Portable Marine Mammal Deterrence Apparatus and Portable Marine Mammal Deterrence System are not limited to the particular embodiments described herein, but is capable of many embodiments without departing from the scope of the claims.

What is claimed:

1. A portable marine mammal deterrence apparatus, comprising:
an insulated cable capable of coupling to an aquatic vessel;
a plurality of cable offshoots, each having a proximal end and a distal end, wherein each proximal end is electrically connected to the insulated cable;
a plurality of deterrence tips, each located at the distal end of each of the plurality of cable offshoots, wherein a marine mammal contacting at least two deterrence tips forms a circuit that provides a deterrent stimulus;
a control system, electrically connected to the insulated cable, designed to selectively electrify the circuit when a resistance is within a deterrence range, further comprising:
a resistance detector configured to measure a resistance of the circuit,
a relay configured to enable electrification of the circuit, and
an alert module configured to provide an intruder notification; and
a power source, electrically connected to the control system, capable of electrifying the circuit.

2. The marine mammal deterrence apparatus of claim 1, wherein the marine mammal is a pinniped.

3. The marine mammal deterrence apparatus of claim 1, wherein the insulated cable is capable of coupling to an aquatic vessel.

4. The marine mammal deterrence apparatus of claim 1, wherein the insulated cable is coupled to an external edge of an aquatic vehicle.

5. The marine mammal deterrence apparatus of claim 1, wherein the plurality of cable offshoots have staggering lengths.

6. The marine mammal deterrence apparatus of claim 1, wherein the power source is a solar array.

7. The marine mammal deterrence apparatus of claim 1, wherein the deterrent stimulus provides a non-lethal electrification to a marine mammal.

8. The marine mammal deterrence apparatus of claim 1, wherein the insulated cable is coupled to an external rail of the aquatic vessel.

9. The marine mammal deterrence apparatus of claim 1, wherein the insulated cable is coupled to a swim steps of the aquatic vessel.

10. A portable marine mammal deterrence system, comprising:
an insulated cable capable of coupling to an aquatic vessel;
a plurality of cable offshoots, each having a proximal end and a distal end, wherein each proximal end is electrically connected to the insulated cable;
a plurality of deterrence tips, each located at the distal end of each of the plurality of cable offshoots, wherein a marine mammal contacting at least two deterrence tips forms a circuit that provides a deterrent stimulus;
a control system, electrically connected to the insulated cable, designed to selectively electrify the circuit when a resistance is within a deterrence range, further comprising:
a resistance detector configured to measure a resistance of the circuit,
a relay configured to enable electrification of the circuit, and
an alert module configured to provide an intruder notification; and
a power source, electrically connected to the control system, capable of electrifying the circuit.

11. The marine mammal deterrence system of claim 10, further comprising an alert system.

12. The marine mammal deterrence system of claim 10, wherein the marine mammal is a pinniped.

13. The marine mammal deterrence system of claim 10, wherein the insulated cable is capable of coupling to an aquatic vessel.

14. The marine mammal deterrence system of claim 10, wherein the insulated cable is coupled to an external edge of an aquatic vehicle.

15. The marine mammal deterrence system of claim 10, wherein the plurality of cable offshoots have staggering lengths.

16. The marine mammal deterrence system of claim 10, wherein the power source is a solar array.

17. The marine mammal deterrence system of claim 10, wherein the deterrent stimulus provides a non-lethal electrification to a marine mammal.

18. The marine mammal deterrence system of claim 10, wherein the insulated cable is coupled to an external rail of the aquatic vessel.

19. The marine mammal deterrence system of claim 9, wherein the insulated cable is coupled to a swim steps of the aquatic vessel.
